(19) United States
(12) Patent Application Publication
(10) Pub. No.: US 2011/0212735 A1
(43) Pub. Date: Sep. 1, 2011

(54) METHOD AND SYSTEM FOR SEAMLESS CONSUMMATION OF AN ELECTRONIC TRANSACTION BASED ON LOCATION RELATED DATA

(76) Inventors: Mark Buer, Gilbert, AZ (US); Charles Abraham, Los Gatos, CA (US); David Garrett, Tustin, CA (US); Jeyhan Karaoguz, Irvine, CA (US); David Lundgren, Mill Valley, CA (US); David Murray, Mission Viejo, CA (US)

(21) Appl. No.: 12/748,104

(22) Filed: Mar. 26, 2010

Related U.S. Application Data
(60) Provisional application No. 61/309,260, filed on Mar. 1, 2010.

(51) Int. Cl. H04W 64/00

(52) U.S. Cl. 455/456.3

(57) ABSTRACT

A mobile device may determine its location, receive transaction related information, and initiate, based on its determined location and/or the transaction related information, a transaction at the current location. The transaction related information may be received from a location server. The mobile device and/or its users may also be authenticated, using the location server. The initiated transaction may be completed automatically, without user input. The device user may also be prompted for authorization and/or information for completing the transaction. The transaction related information may specify if and/or when transactions are to be completed automatically. The mobile device may track user actions via the mobile device, and may generate based on that tracking, user action data pertaining transactions initiated and/or conducted by the user. The generated user action data may be communicated to the location server, and may be used to update the profile data maintained by the location server.

### CROSS-REFERENCE TO RELATED APPLICATIONS/INCORPORATION BY REFERENCE

This patent application makes reference to, claims priority to and claims benefit from U.S. Provisional Application Ser. No. 61/309,260 (Attorney Docket Number 21024US01) filed on Mar. 1, 2010. This application also makes reference to:

U.S. Provisional Application Ser. No. 61/304,947 (Attorney Docket Number 20997US01) filed on Feb. 16, 2010;
U.S. application Ser. No. ______ (Attorney Docket Number 20997US02) filed on even date herewith;
U.S. Provisional Application Ser. No. 61/312,979 (Attorney Docket Number 21007US01) filed on Mar. 11, 2010;
U.S. application Ser. No. ______ (Attorney Docket Number 21007US02) filed on even date herewith;
U.S. Provisional Application Ser. No. 61/312,994 (Attorney Docket Number 21008US01) filed on Mar. 11, 2010;
U.S. application Ser. No. ______ (Attorney Docket Number 21008US02) filed on even date herewith;
U.S. Provisional Application Ser. No. 61/303,794 (Attorney Docket Number 21009US01) filed on Feb. 12, 2010;
U.S. application Ser. No. ______ (Attorney Docket Number 21009US02) filed on even date herewith;

Each of the above stated applications is hereby incorporated herein by reference in its entirety.

### FEDERALLY SPONSORED RESEARCH OR DEVELOPMENT

[Not Applicable].

### MICROFICHE/COPYRIGHT REFERENCE

[Not Applicable].

### FIELD OF THE INVENTION

Certain embodiments of the invention relate to communication. More specifically, certain embodiments of the invention relate to a method and system for seamless consummation of an electronic transaction based on location related data.

### BACKGROUND OF THE INVENTION

Location based services (LBS) applications are emerging as a new type of value-added service provided by mobile communication network. LBS applications are mobile services in which the user location related data is used to enable and/or support various applications and/or services such as, for example, enhanced 911 (E-911), location-based 411, location-based messaging and/or location-based friend finding services. A location of a communication device may be determined in different ways such as, for example, using network-based technology, using terminal-based technology, and/or hybrid technology, which may be a combination of the former technologies. Many positioning technologies such as, for example, Time of Arrival (TOA), Observed Time Difference of Arrival (OTDOA), Enhanced Observed Time Difference (E-OTD) as well as the Global navigation satellite-based systems (GNSS) such as Global Positioning System (GPS), Global Navigation Satellite System (GLONASS), Galileo, and/or Assisted-GNSS (A-GNSS), may be utilized to estimate the location (latitude and longitude) of the mobile device and convert it into a meaningful X, Y coordinate for Location-Based Services provided via wireless communication systems.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for seamless consummation of an electronic transaction based on location related data, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1A is a block diagram illustrating an exemplary communication system that provides location based services to a plurality of mobile devices, in accordance with an embodiment of the invention.

FIG. 1B is a block diagram illustrating an exemplary mobile device that is operable to consummate transactions using location based services (LBS) data and/or services, in accordance with an embodiment of the invention.

FIG. 2 is a block diagram illustrating an exemplary processing system that is operable to support use of location based services (LBS) in a mobile device, in accordance with an embodiment of the invention.

FIG. 3 is a block diagram illustrating an exemplary location server, in accordance with an embodiment of the invention.

FIG. 4 is a flow chart that illustrates exemplary steps for initiating transactions in locations based on location based services (LBS) profile data, in accordance with an embodiment of the invention.

### DETAILED DESCRIPTION OF THE INVENTION

Certain embodiments of the invention may be found in a method and system for seamless consummation of an electronic transaction based on location related data. In various embodiments of the invention, a mobile device may determine its location and may retrieve transaction related information from a server that is operable to support and/or provide location based services (LBS). The mobile device may be operable to consummate one or more transactions at its current location based on its determined location and/or the retrieved transaction related information transaction. Authentication of the mobile device and/or its users may be performed by the server. The consummated transaction may be completed automatically and/or autonomously, without any actions by the user. Alternatively, the mobile device user may be prompted for authorization and/or information for completing the transaction. The mobile device may monitor and/or track user actions via the mobile device, for example during transactions conducted via the mobile device, and may generate based on that tracking, user action data that pertain to these transactions initiated and/or conducted by the mobile device. The generated user action data may be communicated to the server, which may utilize the user action data to generate and/or update transaction related information maintained by the server.

The transaction related information may be configurable to specify if and/or when the transaction may be completed automatically. Configuring of the transaction related information may be performed based on input by the mobile device user(s), and/or based on tracking actions by the user when transactions are conducted via the mobile device. The mobile device may perform additional tasks to ensure successful completion of the consummated transaction. In this regard, the mobile device may obtain, based on its current location for example, additional information regarding entities with whom the transactions are conducted. The additional information may comprise data available online corresponding to businesses and/or places in the determined current location.

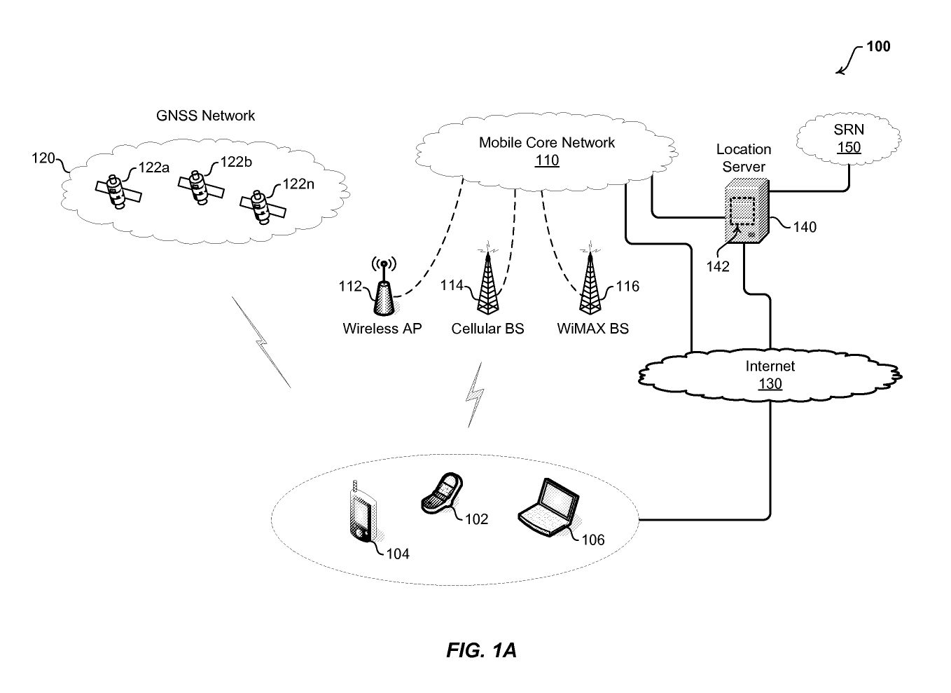

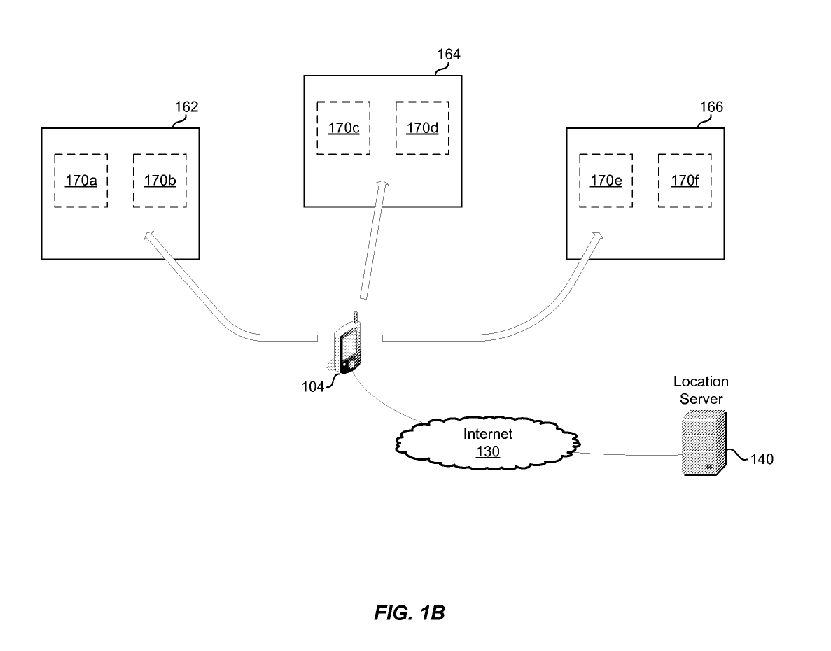

FIG. 1A is a block diagram illustrating an exemplary communication system that provides location based services to a plurality of mobile devices, in accordance with an embodiment of the invention. Referring to FIG. 1A, there is shown a communication system 100 comprising a plurality of mobile device, of which the mobile devices 102-106 are illustrated. Exemplary mobile devices may comprise a cellular device, a Smartphone, a personal digital assistant (PDA), and/or the laptop 106. Also shown in the communication system 100 is a mobile core network 110, a wireless access point (AP) 112, a cellular basestation (BS) 114, a Worldwide Interoperability for Microwave Access (WiMAX) BS 116, a Global Navigation Satellite Systems (GNSS) network 120, a plurality of GNSS satellites 122a-122n, an Internet 130, a location server 140, and a satellite reference network (SRN) 150.

The GNSS network 120 may comprise suitable logic, circuitry, interfaces, and/or code that may provide navigation information to land-based devices via satellite links. In this regard, the GNSS network 120 may comprise, for example, the plurality of GNSS satellites 122a-122n, each of which is operable to provide satellite transmissions based on a global navigation satellite system (GNSS). In this regard, exemplary GNSS systems may comprise, for example, the Global Positioning System (GPS), GLONASS and/or Galileo based satellite system. Accordingly, the GNSS network 120 may be operable to provide positioning information via downlink satellite links transmitted from the one or more of the plurality of GNSS satellites 122a-122n to enable land-based devices, such as the mobile devices 102-106, to determine their locations. In this regard, the plurality of GNSS satellites 122a-122n may directly provide positioning information and/or a land-based device may utilize satellite transmissions from different satellite to determine its location using, for example, triangulation based techniques.

The Internet 130 may comprise a system of interconnected networks and/or devices that enable exchange of information and/or data among a plurality of nodes, based on one or more networking standards, including, for example, Internet Protocols (IP). The Internet 130 may enable, for example, connectivity among a plurality of private and public, academic, business, and/or government nodes and/or networks, wherein the physical connectivity may be provided via the Public Switched Telephone Network (PSTN), utilizing copper wires, fiber-optic cables, wireless interfaces, and/or other standards-based interfaces.

The wireless AP 112 may comprise suitable logic, circuitry, interfaces, and/or code that are operable to provide data services to communication devices, such as one or more of the mobile devices 102-106, in adherence with one or more wireless LAN (WLAN) standards such as, for example, IEEE 802.11, 802.11a, 802.11b, 802.11d, 802.11e, 802.11n, 802.11v, and/or 802.11u. The wireless AP 112 may communicate with the mobile core network 110 and/or the Internet 130, via one or more links and/or associated devices for example. In this manner, the wireless AP 112 may provide network access to the mobile devices 102-106.

The cellular BS 114 may comprise suitable logic, circuitry, interfaces, and/or code that are operable to provide voice and/or data services to communication devices, such as one or more of the mobile devices 102-106, in adherence with one or more cellular communication standards. Exemplary cellular communication standards may comprise Global System for Mobile communications (GSM), General Packet Radio Services (GPRS), Universal Mobile Telecommunications System (UMTS), Enhanced Data rates for GSM Evolution (EDGE), Enhanced GPRS (EGPRS), and/or 3GPP Long Term Evolution (LTE). The cellular BS 114 may communicate with the mobile core network 110 and/or the Internet 130, via one or more backhaul links and/or associated devices for example. In this manner, the cellular BS 114 may provide network access to the mobile devices 102-106.

The WiMAX BS 116 may comprise suitable logic, circuitry, interfaces, and/or code that are operable to provide WiMAX based data services to communication devices, such as one or more of the mobile devices 102-106. The WiMAX BS 116 may communicate with the mobile core network 110 and/or the Internet 130, via one or more backhaul links and/or associated devices for example. In this manner, the WiMAX BS 116 may provide network access to the mobile devices 102-106.

The mobile core network 110 may comprise suitable logic, circuitry, interfaces, and/or code that are operable to provide interfacing and/or connectivity servicing between access networks, which may be utilized by the mobile devices 102-106, and external data networks such as packet data networks (PDNs) and/or the Internet 130. In this regard, the mobile devices 102-106 may access the mobile core network 110 via the wireless AP 112, the cellular BS 114, and/or the WiMAX BS 116. The mobile core network 110 may be configured to communicate various data services, which are provided by external data networks, to associated users such as, for example, the mobile devices 102-106.

Each of the mobile devices 102-106 may comprise suitable logic, circuitry, interfaces, and/or code for implementing various aspects of the invention disclosed herein. In this regard, each of the mobile devices 102-106 may be operable to communicate via a plurality of wired and/or wireless connections, based on various wired and/or wireless protocols and/or standards. For example, each of the mobile devices 102-106 may be operable to transmit and/or receive signals to and/or from one or more of the wireless AP 112, the cellular BS 114, WiMAX BS 116, GNSS network 120, and/or the Internet 130. Also, each of the mobile devices 102-106 may be operable to communicate with, and/or receive services provided by the Internet 130 and/or the mobile core network 110. In this regard, the mobile devices 102-106 may be operable to utilize LBS applications using the location server 140. In an exemplary aspect of the invention, each of the mobile devices 102-106 may be operable to initiate transactions, for mobile device users, at certain locations based on, for example, data and/or services provided by the location server 140.

The location server 140 may comprise suitable logic, circuitry, interfaces, and/or code that are operable to provide and/or support location based services (LBS). In this regard, the location server 140 may be operable to store and/or process location related data pertaining to communication devices in the system 100 for example, such as one or more of the mobile devices 102-106. The location related data may be stored in a reference database 142 in the location server 140. The location server 140 may be operable to collect and/or retrieve location related data from the mobile devices. The location server 140 may also be operable to access and/or communicate with dedicated entities, such as the SRN 150 for example, to collect and/or updated additional location related information. The location server 140 may communicate stored location related data when requested to do so. In an exemplary aspect of the invention, the location server 140 may be operable to maintain and/or provide information which may enable initiating transactions via mobile devices 102-106 at certain locations. In this regard, the reference database 142 may be updated and/or modified to track and store transaction related information using, for example, corresponding user profiles of serviced mobile devices.

The SRN 150 may comprise suitable logic, circuitry, interfaces, and/or code that are operable to collect and/or distribute data for GNSS satellites on a continuous basis. The SRN 150 may comprise a plurality of GNSS reference tracking stations located around the world to provide A-GNSS coverage all the time in both a home network and/or any visited network. In this regard, the SRN 150 may utilize satellite signal received from various GNSS constellations, such as, for example, the plurality of GNSS satellites 122a-122n of the GNSS network 120.

In operation, the location server 140 may be utilized to provide location based services (LBS) in the system 100. The location server 140 may maintain, for example, the reference database 142, which may comprise profile elements corresponding to each of the mobile devices 102-106, and/or users thereof, for example. In order to provide support for LBS applications, the location server 140 may access the SRN 150 to collect GNSS satellite data, and may utilize the collected GNSS satellite data to generate GNSS assistance data (A-GNSS data) pertaining to the mobile devices 102-106. The location server 140 may also collect and/or retrieve location related data directly from the mobile devices 102-106, and/or from other associated entities that interact with the mobile devices 102-106 in the system 100, such as, for example, the wireless AP 112, the cellular BS 114, and/or the WiMAX 116. The retrieved location related data may be stored in reference database 142 in the location server 140. The location server 140 may communicate the stored location related data when requested to do so. In addition, the reference database 142 maintained in the location server 140 may be modified, refined, and/or updated based on retrieved location related data, and/or based on uses of and/or actions performed in the mobile devices. The location related data stored and/or maintained by the location server 140 may be utilized to augment and/or substitute for location related data received and/or generated based on communication with the GNSS network 120, for example, when communication with the GNSS network 120 is disturbed.

The location based services (LBS) applications may be utilized in the system 100 for authentication purposes. In this regard, the location related data stored and/or maintained in the location server 140 may be utilized to authenticate one or more of the mobile devices 102-106, users thereof, and/or locations thereof during operations performed by the mobile devices 102-106. For example, service providers, who may provide access servicing to the mobile devices 102-106, may contact the location server 140 to request that the location server 140 perform any such authentication procedures, and/or to obtain information necessary for performing the authentication procedures directly by the service providers. The service providers may comprise, for example, cellular, WiMAX, and/or WLAN services providers. For example, a service provider of the mobile device 104 may request authenticating the mobile device 104, its user, and location at a given instance. The location server 140 may then perform the necessary authentication procedures, which may be based on existing information in the reference database 142, which is maintained by the location server 140. The location server 140 may also perform authentication procedures based on current information, which may be obtained by, for example, communicating with the mobile device 104, to verify its present location and/or connectivity status or parameters for example. In this regard, the location server 140 may communicate with the mobile device 104 using IP packets that may be communicated via the Internet 130, which may be transmitted to and/or received the mobile device 104 via its Internet connectivity, and/or via its network access via the wireless AP 112, the cellular 114, and/or the WiMAX AP 116.

Furthermore, various security protocols and/or procedures may be used and/or implemented within the system 100 to ensure secure exchange of location related data among, for example, the location server 140, serviced entities that are to be authenticated, such as the mobile devices 102-106 (and/or users thereof); and/or other entities and/or devices that may seek and/or require authentication of serviced devices and/or may provide necessary information during any such operations, such as services providers for any of the mobile devices 102-106.

In an exemplary aspect of the invention, the system 100 may initiate transactions via the mobile devices 102-106 at certain locations based on information retrieved from the location server 140. In instances where location of a mobile device, such as the mobile device 104, is determined, electronic transactions within that location may be seamlessly initiated based on the determination of the location and/or additional information, which may be based on LBS applications. For example, transactions may be consummated whenever the mobile device 104 may be at a particular or specified location based on authenticated user profiles, which may be retrieved from location server, such as, for example, the location server 140. In this regard, location related data stored and/or maintained in the reference database 142 in the location server 140 may be updated based on, for example, tracking of mobile device users' actions in specific locations. For example, by tracking location and/or uses of the mobile device 104, it may be determined that a user of the mobile 104 makes certain transactions, such as purchasing coffee at a specific coffee store, at a specific location, and/or specific time and/or specific days. Accordingly, an authenticated user profile element in the reference database 142 of the location server 140 which corresponds to that particular user of the mobile device 104 may be updated and/or augmented with that data, which may comprise the location, any additional information such as the time and/or the day, and/or information pertaining to the transactions performed. Subsequently, in instances when a match is determined, based on a current location of the mobile device 104, and/or any additional matching data such as the current time and/or day, similar transactions may be consummated for that particular user of the mobile device 104. For example, when the current location of the mobile device 104 and/or current time/day information match information corresponding to prior coffee transactions, a new coffee purchase transaction may be consummated.

In instances where transactions are consummated, these transactions may be completed automatically, without requiring any input from the user for example. Alternatively, device users may be prompted to complete the transactions. In this regard, users may be prompted, for example, to authenticate the transactions and/or to provide additional information that may be necessary to complete the transactions, such as billing information for example. Determining whether and/or when to complete transactions autonomously and/or when to prompt the user for authorization to continue the transaction may be controlled by one or more configurable parameters in the authenticated user profile. In this regard, the configuration may be performed based on input by the user, for example via the mobile device 104.

In some embodiments of the invention, the mobile devices may perform additional tasks to further refine and/or assist in completing transactions that may be initiated using LBS based data and/or applications. For example, after determining the location of a mobile device, such as the mobile device 104, and/or determining, based on an authenticated user profile for example, that a transaction with a nearby business at that location may be performed, the mobile device 104 may obtain additional information that may enable the user to complete the transaction. In this regard, once the mobile device 104 determines, using LBS based data and/or applications, the nearby business, an online search may be performed, via the Internet 130 for example, to find and/or display available information, such as any menus and/or listings of available products and/or services, which may enable the user to make a selection when conducting a purchase, for example.

While the invention has been described herein with regard to purchasing related transactions, the invention need not be so limited, and may be extended to any type of transactions that may be initiated and/or conducted via mobile devices, based on determination of their location and/or additional data which may be available from LBS applications.

FIG. 1B is a block diagram illustrating an exemplary mobile device that is operable to consummate transactions using location based services (LBS) data and/or services, in accordance with an embodiment of the invention. Referring to FIG. 1B, there is shown mobile device 104 and the location server 140 of FIG. 1A, which may interact via the Internet 130. Also shown in FIG. 1B is a plurality of locations 162-166, comprising a plurality of businesses 170a-170f. Exemplary businesses may comprise stores, restaurants, and/or coffee shops.

In operation, transactions may be consummated in the mobile device 104 at specific locations, such as one or more of the locations 162-166, using LBS data and/or application, substantially as described with regard to FIG. 1A. In this regard, the location of the mobile device 104 may be first determined. Determining the location of the mobile device 104 may be performed directly within the mobile device 104 based on, for example, GNSS satellite signals received from the GNSS network 120. Determining the location of the mobile device 104 may also be based on LBS data and/or applications provided by, for example, the location server 140, which the mobile device 104 may communicate with via the Internet 130. The location server 140 may also be operable to perform device and/or user authentication based on, for example, data and/or profiles that may be maintained in the reference database 142. Once the location of the mobile device 104 is determined, and/or device and/or user authentication is performed, transactions may be initiated via the mobile device 104 based on the determined location and/or information that may be retrieved from the location server 140. For example, in instances where the location of the mobile device 104 is determined to be the location 162, transactions with businesses 170a and/or 170b may be initiated based on LBS related data retrieved from the location server 140. To initiate these transactions, additional information, beside the location, may be considered. For example, the LBS related data retrieved from the location server 140 may comprise information regarding prior transactions with businesses 170a and/or 170b, which were previously conducted via the mobile device in the location 162. In this regard, the retrieved LBS related data may comprise, for example, information regarding times and/or days when any such transactions were conducted. In some embodiments of the invention, initiation and completion of transaction at a location may be treated as separate transactions. For example, initiating of a transaction via the mobile device 104 with business 170a (e.g. placing an order), and completion of the transaction (e.g. payment) may be treated as two separate transactions. Accordingly, different criteria and/or condition for consummating each transaction, and/or configuration data for determining how to conduct each of the two transactions, may be specified and/or utilized.

The retrieved LBS related data may also specify additional information regarding how and/or when to initiate and/or complete the transaction. For example, the retrieved LBS related data may specify that the transactions are to be performed and completed automatically, without any input from the user, and may also specify additional information necessary for completing the transaction, such as billing information. Alternatively, the retrieved LBS related data may specify the user must be prompted to authenticate and/or approve completion of the consummated transactions, and/or to provide certain information, such as billing preferences and/or data.

In instances where the retrieved LBS related data may not specify any consummation of transactions at a determined location, because no prior transactions may have been conducted for example, the mobile device 104 may monitor actions by the user at that location, to track any transactions performed therein. The mobile device 104 may then attempt to update the corresponding mobile device and/or user profiles based on the newly tracked transactions. For example, in instances where the location of the mobile device 104 is determined to be location 166, the retrieved LBS based data may not specify that any transactions are to be consummated at that location.

The mobile device 104 may continue to monitor actions undertaken by the device users at location 166. Accordingly, in instances where the device user conducts transactions, using the mobile device 104, with businesses 170e and/or 170f, the mobile device 104 may generate updated transaction data that may comprise, for example, information identifying the location 166 and indicating that transactions were performed therein. The updated transaction data may also comprise addition information regarding the transactions, which may comprise information identifying the entities with whom the transactions where conducted (e.g. business 170e); time related information specifying, for example, the time, day, and/or date when the transactions were conducted; information regarding the device user's selections; and/or billing and/or payment related information. The transaction update data may then be communicated to the location server 140, via the Internet 130 for example, wherein the location server 140 may utilize the updated transaction data to update, for example, profile elements in the reference database 142 corresponding to the mobile device 140 and/or users thereof.

In some embodiments of the invention, additional tasks may be required and/or specified, based on LBS based data and/or applications, to further refine and/or assist in completing transactions which may be consummated at certain locations. For example, in instances where the location of the mobile device 104 is determined to be the location 164, the retrieved LBS based data may specify that the mobile device 104 obtain additional information regarding businesses 170c and/or 170d. The additional information may be used to assist the device user in completing transactions that may be consummated with businesses 170c and/or 170d. In this regard, the mobile device 104 may perform an online search, via the Internet 130 for example, to find and/or display available information regarding businesses 170c and/or 170d, which may be useful in conducting these transactions. Exemplary information obtainable via the Internet 130 may comprise work schedules, menus, and/or listings of available products and/or services.

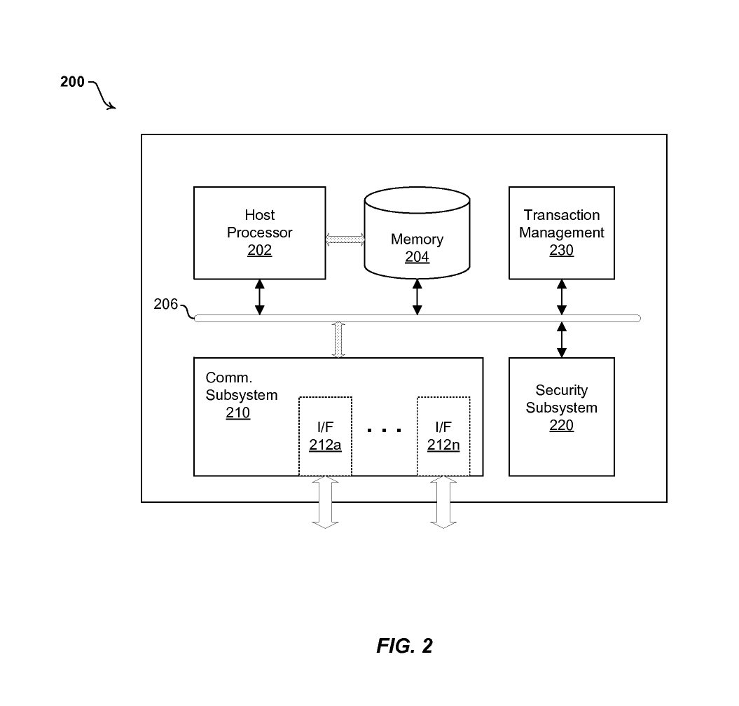

FIG. 2 is a block diagram illustrating an exemplary processing system that is operable to support use of location based services (LBS) in a mobile device, in accordance with an embodiment of the invention. Referring to FIG. 2 there is shown a device 200, a host processor 202, a system memory 204, a system bus 206, a communication subsystem 210, a plurality of interface processing blocks 212a-212n, a security subsystem 220, and a transaction management processing block 230.

The device 200 may comprise the host processor 202, the system memory 204, the system bus 206, the communication subsystem 210, the security subsystem 220, and the transaction management processing block 230. The device 200 may correspond to, for example, each of the mobile devices 102-106 of FIG. 1A. In this regard, the device 200 may enable reception and/or transmission of signals during communication via one or more wired and/or wireless connections. The device 200 may also be operable to support LBS applications. In an exemplary aspect of the invention, the device 200 may support consummation and/or completion of transactions at certain locations using, for example, LBS data and/or applications.

The host processor 202 may comprise suitable logic, circuitry, interfaces, and/or code that may be operable to process data and/or control operations of the device 200. In this regard, the host processor 202 may be operable to configure and/or control operations of various components and/or systems of the device 200, by providing, for example, control signals. The host processor 202 may also control data transfers within the device 200. The host processor 202 may enable execution of applications, programs and/or code, which may be stored in the system memory 204 for example, to enable performing various web browsing support operations.

The system memory 204 may comprise suitable logic, circuitry, interfaces, and/or code that enable permanent and/or non-permanent storage and/or fetching of data, code and/or other information used in the device 200. In this regard, the system memory 204 may comprise different memory technologies, including, for example, read-only memory (ROM), random access memory (RAM), and/or Flash memory. The system memory 204 may store, for example, information comprising configuration data used during LBS operations in the device 200. The configuration data may comprise parameters and/or code, which may comprise software and/or firmware, but the configuration data need not be limited in this regard.

The system bus 206 may comprise suitable logic, circuitry, interfaces, and/or code that may enable exchange of data and/or information between various components and/or systems in the device 200. In this regard, the system bus may comprise parallel or serial, and/or internal or external based bus technologies, and/or any combinations thereof. Exemplary system bus interfaces may comprise Inter-Integrated Circuit (I²C), Universal Serial Bus (USB), Advanced Technology Attachment (ATA), Small Computer System Interface (SCSI), Peripheral Component Interconnect (PCI), and/or Peripheral Component Interconnect Express (PCI-e) based interfaces.

The communication subsystem 210 may comprise suitable logic, circuitry, code, and/or interfaces that may enable communication of data, content, and/or messaging from and/or to the device 200, based on one or more wired and/or wireless protocols. The communication subsystem 210 may comprise, for example, the plurality of I/F processing blocks 212a-212n that may be operable to perform communication based on wired or wireless standards supported in the device 200. In this regard, each of the plurality of I/F processing blocks 212a-212n may comprise suitable logic, circuitry, interfaces, and/or code that are operable to detect, receive, and/or transmit signals based on specific frequency bands and/or modulation schemes. The I/F processing blocks 212a-212n may also be operable to perform necessary processing operations, which may comprise, for example, buffering, filtering, modulation/demodulation, up-conversion/down-conversion, and/or digital-to-analog/analog-to-digital conversion. The plurality of the IF processing blocks 212a-212n may be configured to support, for example, transmission and/or reception of RF signals during communication based on Ethernet, Bluetooth, WLAN, cellular, WiMAX, GNSS, FM interfaces and/or protocols.

The security subsystem 220 may comprise suitable logic, circuitry, interfaces, and/or code that may operable to perform security related operations in the device 200. In this regard, the security subsystem 220 may perform device and/or user authentication, certificate usage, and/or cryptographic operations in the device 200.

The transaction management processing block 230 may comprise suitable logic, circuitry, interfaces, and/or code that may operable to perform and/or support transactions via the device 200. In this regard, the transaction management processing block 230 may initiate and/or complete electronic transactions utilizing, for example, LBS data and/or applications. While the transaction management processing block 230 is shown as a separate component within the device 200, the invention need not be so limited. For example, the functionality and/or operations described herein with regard to the transaction management processing block 230 may be performed by other components of the device 200, such as the host processor 202 for example.

In operation, the device 200 may be utilized to perform network access and/or communication based on one or more wired or wireless interfaces. In this regard, the device 200 may provide network accessibility and/or communication, via the communication subsystem 210, with the wireless AP 112, the cellular BS 114, the WiMAX BS 116, and/or the Internet 130. During operations in the device 200, the host processor 202 may manage and/or control operations of, for example, communication subsystem 210 and/or security subsystem 220. In an exemplary aspect of the invention, the device 200 may be operable to support LBS application. In this regard, the device 200 may communicate, using the communication subsystem 210, with a location server, such as the location server 140 of FIG. 1A. The device 200 may interact with the location server 140 via the internet 130, using, for example, the I/F processing block 212a, which may be configurable for LAN based Ethernet communications. During LBS related operations in the device 200, the security subsystem 220 may support various authentication and/or confidentiality related operations performed via the device 200. In this regard, the security subsystem 220 may assist and/or interact with the location server 140, for example, to enable performing mobile device and/or user authentication procedures.

In various embodiments of the invention, the device 200 may consummate transactions at specific locations, using, for example, LBS data and/or applications, substantially as described with regard to FIGS. 1A and 1B. In this regard, the device 200 may determine its current location, which may be done using, for example, GNSS signals received via one or more of the plurality of I/F processing blocks 212a-212n in the communication subsystem 210, and/or based on based on LBS data and/or applications provided by, for example, the location server 140. The security subsystem 220 may then perform, in conjunction with a location server such as the location server 140, user authentication based on, for example, LBS based data and/or applications. Once the location of the device 200 is determined, and/or device and/or user authentication is performed, transactions may be initiated and/or completed, via the transaction management processing block 230 in the device 200 for example, based on the determined current location of the device 200 and/or LBS based data and/or applications, substantially as described with regard to FIGS. 1A and 1B.

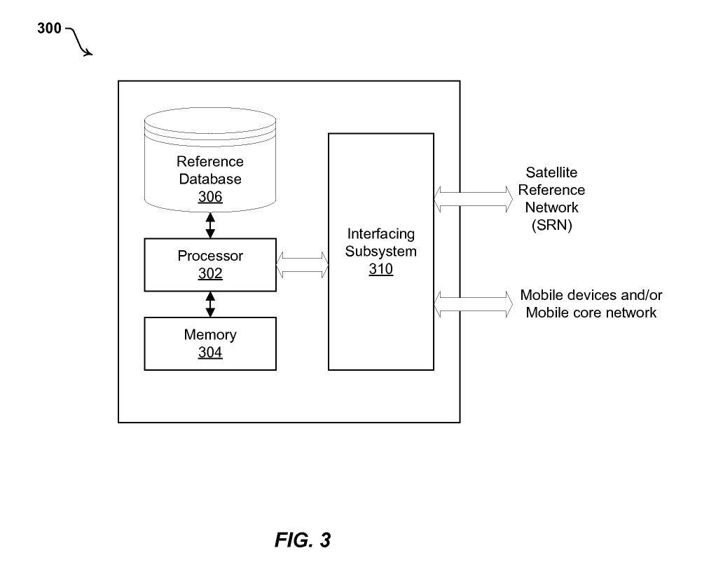

FIG. 3 is a block diagram illustrating an exemplary location server, in accordance with an embodiment of the invention. Referring to FIG. 3 there is shown a server 300, a processor 302, a memory 304, a reference database 306, and an interfacing subsystem 310.

The server 300 may comprise the processor 302, the memory 304, the reference database 306, and the interfacing subsystem 310. The server 300 may correspond to, for example, the location server 140 of FIGS. 1A and 1B. In this regard, the server 300 may be operable to provide and/or support location based services (LBS). In an exemplary aspect of the invention, the server 300 may maintain, via the reference database 306 for example, data that may be used via mobile devices serviced by the server 300 to initiate and/or complete transactions at certain locations. In this regard, the reference database 306 may be updated and/or modified based on data provided to the server 300 by, for example, the serviced mobile devices.

The processor 302 may comprise suitable logic, circuitry, interfaces, and/or code that may be operable to manage and/or control operations of the server 300. In this regard, the processor 302 may be operable to configure and/or control operations of various components and/or systems of the server 300, by providing, for example, control signals. The processor 302 may also control data transfers within the system 300, including data storage and/or retrieval from memory 304 and/or generating, storing, and/or updating elements in the reference database 306. The processor 302 may enable execution of applications, programs and/or code, which may be stored in the memory 304 for example, to enable performing various services and/or application requested from the server 300, including location based services (LBS) applications for example. The memory 304 may comprise suitable logic, circuitry, interfaces, and/or code that enable permanent and/or non-permanent storage and/or fetch of data, code and/or other information used in the server 300. In this regard, the memory 304 may comprise different memory technologies, including, for example, read-only memory (ROM), random access memory (RAM), and/or Flash memory. The memory 304 may be operable to store, for example, data and/or code used during LBS operations in the server 300. The data and/or code may comprise configuration data or parameters, and the code may comprise operational code such as software and/or firmware, but the information need not be limited in this regard.

The reference database 306 may comprise suitable logic, circuitry, interfaces, and/or code that may be operable to store location related data of associated communication devices such as, for example, the mobile devices 102-106. The reference database 306 may be internally or externally coupled to the server 300. The stored location related data may be provided to associated devices and/or users to support LBS applications. The reference database 306 may be operable to manage and update the stored location related data when requested, dynamically whenever any change is detected, and/or periodically. In an exemplary aspect of the invention, the reference database 306 may comprise data which may be retrieved by mobile devices serviced via the server 300 to consummate and/or complete transactions at certain locations. Furthermore, the reference database 306 may be updated and/or modified based on data communicated to the server 300 by, for example, the serviced mobile devices.

The interfacing subsystem 310 may comprise suitable logic, circuitry, interfaces, and/or code that may enable communication of data, content, and/or messaging from and/or to the server 300. The interfacing system 310 may support, for example, a plurality of physical and/or logical connections, based on one or more wired and/or wireless interfaces in the server 300. In this regard, the interfacing system 330 may comprise, for example, one or more network interface cards (NIC) and/or wireless network interface cards (WNIC).

In operation, the server 300 may be utilized to provide location based services (LBS). To facilitate LBS operations and/or servicing via the server 300, the processor 302 may be operable to communicate, via the interfacing subsystem 310, with a satellite reference network (SRN), such as the SRN 150, to collect, for example, GNSS satellite data by tracking GNSS constellations. The processor 302 may utilize the collected GNSS satellite data to build and/or update the reference database 306, which may be coupled internally or externally to the server 300. The processor 302 may retrieve or collect location related data from associated users, such as the device 200. The server 300 may provide location related data by retrieving it from the reference database 306. In this regard, the server 300 may store the location related data in the reference database 306 as elements that may be indexed using identifiers that are specific to serviced devices and/or users thereof.

In an exemplary aspect of the invention, the reference database 306 store and/or maintain, via the reference database 306 for example, data and/or information which may be utilized to consummate and/or complete transactions at certain locations, substantially as described with regard to FIGS. 1A and 1B. The transaction related data may be stored into, for example, profiles maintained via the reference database 306, and corresponding to mobile devices (or users thereof) serviced by the server 300. In this regard, during transaction consummation operations, the server 300 may perform device and/or user authentication procedures with the serviced devices, such as the device 200. Once the location of the serviced devices is determined, the server 300 may be requested to provide device and/or user profiles, which may comprise transaction related information. The profiles may be retrieved from the reference database 306, by the processor 302 for example, and may then be communicated to the serviced devices via the interfacing subsystem 310.

The server 300 may receive, via the interfacing subsystem 310 for example, messaging that may enable configuring existing device and/or user profiles for transaction related operations. For example, mobile devices services via the server 300 may communicated with the server 300 to specify that transaction consummated at certain location are completed automatically or that the user may be prompted for authentication and/or to provide additional information, substantially as described with regard to FIGS. 1A and 1B. The server 300 may also receive, via the interfacing subsystem 310 for example, updated transaction data, which may be generated by serviced devices, substantially as described with regard to FIGS. 1A and 1B. In this regard, the updated transaction data may comprise information pertaining to transactions performed in new locations and/or new transactions in existing location that were not previously tracked. The updated transaction data may be processed, via the processor 302 for example. Processing the received updated transaction data may enable updating corresponding mobile device and/or user profiles, for example, which may be maintained in the reference database 306.

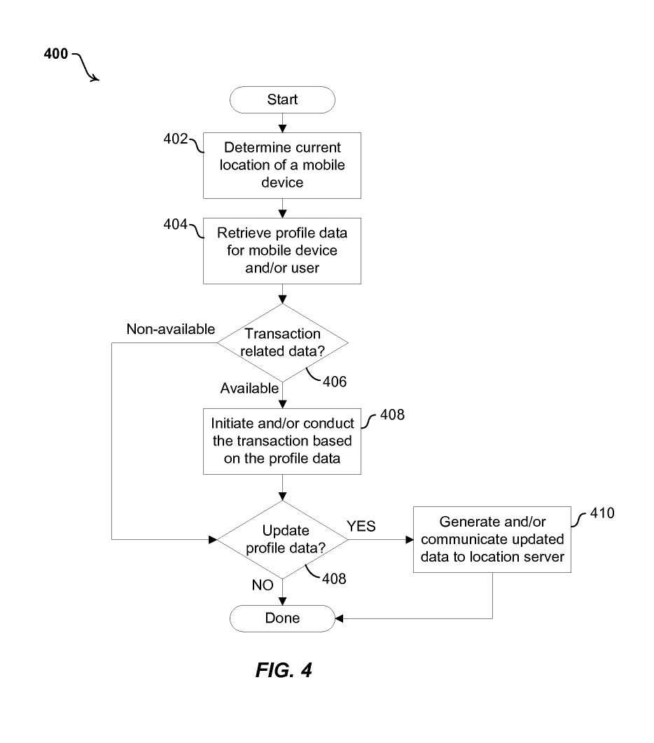

FIG. 4 is a flow chart that illustrates exemplary steps for initiating transactions in locations based on location based services (LBS) profile data, in accordance with an embodiment of the invention. Referring to FIG. 4, there is shown a flow chart 400 comprising a plurality of exemplary steps that may be performed to initiate transaction via mobile devices at specific locations based on LBS data.

In step 402, a current location of a mobile device may be determined. For example, the current location of the mobile device 104 may be determined utilizing, the GNSS signals and/or LBS application, which may be provided via the location server 140. In step 404, profile data for the mobile device and/or user thereof may be retrieved. For example, user profile data corresponding to the mobile device 104, and/or users of the mobile device 104, may be retrieved from, for example, the location server 140. Furthermore, various authentication procedures may be performed during this step, based on interactions between the mobile device 104, the location server 140, and/or the mobile core network 110, to authenticate the mobile device 104, its location, and/or present users thereof. In step 406, a determination of whether transaction related data is available may be performed. In this regard, the mobile device 104 may parse through the retrieved profile data to determine whether the retrieve data comprise information pertaining to transaction that may be consummated in the determined current location of the mobile device 104. The transaction related information may be incorporated into the profile data stored in the location server 140 based on, for example, one or more prior transactions performed and/or initiated by the mobile device user at the current location. In instances where no prior transaction related information is available, the plurality of exemplary steps may proceed to step 408.

In step 408, a determination whether to update profile data with transaction related information may be performed. In this regard, the mobile device 104 may determine whether user profile corresponding to a user of the mobile device 104, which may be maintained in the location server 140, would need to be updated. The update may be performed based on, for example, a determination of whether any transaction were being performed at the determined current location and/or based on input and/or preferences specified by the users. In instances where updated profile data is required, the plurality of exemplary steps may proceed to step 410. In step 410, transaction related data may be generated and/or communicated to the location server 140, wherein the corresponding profile elements may be updated therein.

Returning to step 406, in instances where transaction related information is available, the plurality of exemplary steps may proceed to step 412. In step 412, transaction may be initiated at the determined current location based on the profile data. For example, transaction with the business 170b in the location 162 may be initiated via the mobile device 104 based on profile data retrieved from the location server 140, which may comprise information regarding similar transaction previously performed when the mobile device 104 was also in the location 162. The transaction may be completed automatically or the user may be prompted to authenticate and/or authorize the transaction, and/or to provide information that may be necessary for completion the transaction. In this regard, the user may be prompted to choose the method of payment and/or provide necessary billing information.

Various embodiments of the invention may comprise a method and system for seamless consummation of an electronic transaction based on location related data. The device 200 may determine its location and may retrieve transaction related information from the server 300. The transaction information may be stored in the reference database 306 for example. The transaction management processing block 230 may enable the device 200 to consummate a transaction at its current location based on the determined location and/or the retrieved transaction related information for that current location. Authentication of the device 200 and/or its users may be performed using the security subsystem 220 in the device 200, and the server 300. The consummated transaction may be completed automatically and/or autonomously, without any actions by the user. Alternatively, the device 200 user may be prompted for authorization and/or information for completing the transaction.

The device 200 may monitor and/or track, via the host processor 202 for example, user actions by the device 200, during transactions conducted via the device 200 for example, and may generate via the transaction management processing block 230, based on that tracking, user action data that pertain to these transactions initiated and/or conducted via the device 200. The generated user action data may be communicated to the server 300, via the communication subsystem 210 in the device 200 and the interfacing subsystem 310 in the server 300. The server 300 may utilize the user action data to generate and/or update transaction related information maintained by the server 300. The transaction related information and any updates thereof may be stored in the reference database 306.

The transaction related information may be configured so as to specify if and/or when the transaction may be completed automatically. Configuring the transaction related information may be performed based on input by the device 200 user(s), and/or by based on tracking actions by the user when transactions are conducted via the device 200. The device 200 may perform additional tasks to ensure successful completion of the consummated transaction. In this regard, the device 200 may obtain, based on determination of its current location, additional information regarding entities with whom the transactions are conducted. The additional information may comprise data available online corresponding to businesses and/or places in the determined current location.

In other embodiments, the device 200 may determine its location, receive transaction related information, and initiate, based on the transaction related information a transaction at the determined current location. The transaction related information may be received from a server 300. The device 200, and/or its users may also be authenticated, using the server 300 for example. The initiated transaction may be completed automatically, without user intervention and/or user input. Alternatively, the device user may be prompted for authorization and/or information for completing the initiated transaction. The transaction related information may specify, for example, whether or not the initiated transaction may be completed with or without user input, respectively. The transaction related information may indicate whether the initiated transaction is to be performed based on input by the user and/or based prior actions by the user at the current determined location. The device 200 may track user actions via the device 200, and may generate based on that tracking, user action data pertaining transactions initiated and/or conducted by the user. The generated user action data may be communicated to the server 300, and may be used to update the profile data maintained by the server 300.

Other embodiments of the invention may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the steps as described herein for seamless consummation of an electronic transaction based on location related data.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for communication, the method comprising:
in a mobile device that supports location based services (LBS):
determining a current location of said mobile device;
receiving profile data pertaining to said mobile device and/or a user of said mobile device based on said determined current location; and
initiating a transaction at said determined current location based on said retrieved profile data.

2. The method according to claim 1, wherein said mobile device and/or said user of said mobile device are authenticated prior to completing said initiated transaction.

3. The method according to claim 1, comprising completing said initiated transaction automatically without user intervention and/or user input.

4. The method according to claim 1, comprising prompting said user to complete said initiated transaction.

5. The method according to claim 1, comprising generating data corresponding to said initiated transaction based on user actions in said mobile device.

6. The method according to claim 5, comprising communicating said user action data to a remote location server, wherein said remote location server updates said profile data associated with said mobile device and/or said user of said mobile device based on said communicated user action data.

7. The method according to claim 1, wherein said profile data specifies whether or not said transaction is to be completed with or without user input, respectively.

8. The method according to claim 1, wherein said profile data indicates whether said transaction is to be performed based on input by said user and/or based on prior actions by said user at said current location.

9. The method according to claim 1, comprising initiating said transaction based on information related to surroundings of said determined current location.

10. The method according to claim 9, comprising receiving said profile data from a remote location server.

11. A system for communication, the system comprising:
one or more processors and/or circuits for use in a mobile device which is operable to support location based services (LBS), said one or more processors and/or circuits are operable to:
determine a current location of said mobile device;
receive profile data pertaining to said mobile device and/or a user of said mobile device based on said determined current location; and
initiate a transaction at said determined current location based on said retrieved profile data.

12. The system according to claim 11, wherein said mobile device and/or said user of said mobile device are authenticated prior to completing said initiated transaction.

13. The system according to claim 11, wherein said one or more processors and/or circuits are operable to complete said initiated transaction automatically without user intervention and/or user input.

14. The system according to claim 11, wherein said one or more processors and/or circuits are operable to prompt said user to complete said initiated transaction.

15. The system according to claim 11, wherein said one or more processors and/or circuits are operable to generate data corresponding to said initiated transaction based on user actions in said mobile device.

16. The system according to claim 15, wherein said one or more processors and/or circuits are operable to communicate said user action data to a location server, wherein said location server is operable to update said profile data associated with said mobile device and/or said user of said mobile device based on said communicated user action data.

17. The system according to claim 11, wherein said profile data specifies whether or not said transaction is to be completed with or without user input, respectively.

18. The system according to claim 11, wherein said profile data indicates whether said transaction is to be performed based on input by said user and/or based on prior actions by said user at said current location.

19. The system according to claim 11, wherein said one or more processors and/or circuits are operable initiate said transaction based on information related to surroundings of said determined current location.

20. The system according to claim 19, wherein said one or more processors and/or circuits are operable to receive said profile data from a remote location server.
